(19) United States
(12) Patent Application Publication
(10) Pub. No.: US 2022/0275577 A1
(43) Pub. Date: Sep. 1, 2022

(54) SURFACE MODIFIED CELLULOSE FIBER

(71) Applicant: SAPPI Netherlands Services B.V., Maastricht (NL)

(72) Inventor: Wim BALLET, Riemst (BE)

(73) Assignee: SAPPI Netherlands Services B.V., Maastricht (NL)

(21) Appl. No.: 17/627,148

(22) PCT Filed: Jul. 13, 2020
(86) PCT No.: PCT/EP2020/069743

§ 371 Date: Jan. 14, 2022

(30) Foreign Application Priority Data
Jul. 17, 2019 (EP) 19186844.7

(51) Int. Cl. D21C 9/00; C08L 23/12

(52) U.S. Cl. CPC D21C 9/005; C08L 23/12; C08L 2205/16

(57) ABSTRACT

A process for producing surface modified bleached chemical pulp fiber comprising fluidizing the bleached chemical pulp fiber and contacting the fluidized bleached chemical pulp fiber with an aerosol of a surface modifying composition comprising a surface modifying compound

### TECHNICAL FIELD

The present invention relates to process for producing surface modified bleached chemical pulp fiber in view of their incorporation into a variety of polymer matrices.

### PRIOR ART

In the field of polymer composites, in particular fiber reinforced composites the quality of dispersion of the fibers encapsulated in the polymer matrix is of paramount importance, since a better dispersion generally enables better mechanical properties when compared to the case where undispersed fibers clump together into inclusions also known as “flocks”.

Some fibers and in particular plant-sourced fibers such as wood fibers are more demanding when compared to inorganic fibers such as glass fibers in the sense that they are not easily incorporated into a polymer matrix.

There exist multiples strategies seeking to afford better dispersion of the fibers such as plant-sourced fibers in the polymer matrix. For instance, higher shear forces may be used during the incorporation of the fiber into the polymer matrix, but this relatively straightforward measure on one hand leads to a process requiring considerable energy investment, which is undesirable in view of cost considerations and on the other hand will be detrimental to the quality of fibers which are then shortened due to the high shear. Another strategy is that of preparing feed granules via hot-cold mixers, where plant-sourced fibers are preliminarily combined with granules of polymer matrix in a first “hot” stage of the hot-cold mixer until the fibers essentially stick to the polymer pellets softening as a result of frictional heat and where the thus formed fiber/polymer clumps are dumped into the “cold” stage of the cold mixer where the are agitated to avoid the formation of larger clumps. The thus prepared fiber/polymer clumps can be introduced into an extruder in which the this mix of fiber and polymer matric is further mixed and blended to arrive at a satisfactory degree of dispersion. However, this strategy requires the use of special equipment such as the hot-cold mixer, which represents significant capital expenditure and requires precise control of the process.

Thus, there exist a need to provide a solution to the above dilemma in the production of the fiber reinforced composites, by which either the mixture of fibers and of polymer matrix is incorporated into the polymer matrix using potentially damaging shear forces and at high energetic cost or by which the mixture of fibers and of polymer matrix is manufactured into intermediate fiber/polymer clumps on non-conventional and expensive machinery prior to the production of the fiber reinforced composites.

### SUMMARY OF THE INVENTION

The above-mentioned problems are solved or alleviated by the process according to the present invention which provides for plant-based fibers that can be incorporated into polymer matrices without the need for exerting damaging shear forces on the mixture of plant-based fibers via energy-intensive treatment and without the need for complex formation of intermediate fiber/polymer clumps.

The plant-based fibers obtained by the process according to the invention allow easy incorporation thereof into a polymer matrix on conventional equipment at moderate shear forces.

It is an object of the present invention to provide a process for producing surface modified bleached chemical pulp fiber comprising fluidizing the bleached chemical pulp fiber and contacting the fluidized bleached chemical pulp fiber with an aerosol of a surface modifying composition comprising a surface modifying compound.

In the context of the present invention, the term “surface modified bleached chemical pulp fiber” refers to bleached chemical pulp fiber that has been modified by either the adhesion/adsorption of a surface modifying compound onto the bleached chemical pulp fiber or by the chemical bond formation between the surface modifying compound and the bleached chemical pulp fiber.

In the process for producing surface modified bleached chemical pulp fiber according to the present invention, the fluidized bleached chemical pulp fiber is contacted with an aerosol such that the surface modifying composition comprising a surface modifying compound can deposit on the bleached chemical pulp fiber upon collision of the fluidized bleached chemical pulp fiber with an aerosol droplet/liquid particle of the surface modifying composition.

The fluidized bleached chemical pulp fiber may be contacted with an aerosol in a suitable device capable of fluidizing the bleached chemical pulp fiber and of providing an aerosol of surface modifying composition comprising a surface modifying compound. Suitable devices may be for example devices equipped with a mixing cavity featuring a rotary mixing means that can form a vortex of bleached chemical pulp fiber and which are further equipped with a spray nozzle capable of generating and delivering an aerosol into the mixing cavity. Other suitable devices may be fluid bed reactors in which the bleached chemical pulp fiber is fluidized by a flow of, preferably heated, air that may comprise the aerosol of a surface modifying composition comprising a surface modifying compound, or the aerosol may also be sprayed on separately, preferably without using additional mechanical mixing means.

The amount of surface modifying compound that is ultimately deposited onto the surface modified bleached chemical pulp fiber can be influenced by for example controlling the time during which the fluidized bleached chemical pulp fiber is contacted with an aerosol, or for example by controlling the size of the droplets in the aerosol or for example by controlling the amount of surface modifying compound comprised in the a surface modifying composition, other parameters can be nozzle, size flow rate, or the pressure of the liquid and the blowing air.

The surface modifying composition may comprise one or more surface modifying compounds, which may or may not be capable of a chemical reaction with the cellulose molecules of the bleached chemical pulp fiber under the conditions experienced during the surface modification of the bleached chemical pulp fiber. In one embodiment, the surface modifying composition aerosol is applied at atmospheric pressure and at room temperature, i.e at roughly 1 atm and 25° C. In the case where a silane is used in the surface modifying composition, the temperature may be increased up to 120° C. or higher, with the proviso of not thermally degrading the bleached chemical pulp fiber, in order to facilitate the adhesion of silane-type surface modifying compounds via hydrolysis.

In the case where the one or more surface modifying compound is not capable of a chemical reaction with the cellulose molecules of the bleached chemical pulp fiber during the surface modification of the bleached chemical pulp fiber, the applied one or more surface modifying compounds may be heat activated when the thermoplastic polymer in a melt is mixed with surface modified bleached chemical pulp fiber such as to chemically react with the cellulose molecules of the bleached chemical pulp fibers via formation of a chemical bond between the surface modifying compound and the cellulose molecules of the bleached chemical pulp fibers.

Exemplary surface modifying compounds which undergo heat activation are coupling agents based on one or more dicarboxylic alkenoic acid anhydrides. Such coupling agents are generally available as grafted polyolefins such as MAPP or MAPE.

In the case where the one or more surface modifying compound is capable of a chemical reaction with the cellulose molecules of the bleached chemical pulp fiber during the surface modification of the bleached chemical pulp fiber, the applied one or more surface modifying compound may be water activated when the bleached chemical pulp fiber is contacted with the one or more surface modifying compound such as to chemically react with the cellulose molecules of the bleached chemical pulp fibers via formation of a chemical bond between the surface modifying compound and the cellulose molecules of the bleached chemical pulp fibers.

Exemplary surface modifying compounds which undergo water activation are coupling agents based on one or more silanes preferably having one or more, more preferably two or three, hydrolysable substituent groups such as alkoxy groups (—OR) or halogens which can react in the presence of water to then graft onto the cellulose molecule. Exemplary silanes that may be used are triethoxy octylsilane, triethoxy isobutylsilane, triethoxy propylsilane, or potassium methyl siliconate.

The bleached chemical pulp fiber may be sourced from a variety of chemical pulping processes including, but not limited to Kraft, sulphite or sulphate pulping. Correspondingly, the bleached chemical pulp fiber may be bleached Kraft pulp fiber, bleached sulphite pulp fiber or bleached suphate pulp fiber. In a preferred embodiment, the bleached chemical pulp fiber may be bleached dissolving pulp and in particular may be an unrefined bleached chemical pulp fiber.

In the context of the present invention, the bleached chemical pulp fiber may be in the form of individual fibers, which can be obtained by milling pulp sheets of bleached chemical pulp fiber in for example a knife mill. If the bleached chemical pulp fiber is in the form of individual fibers, the entire surface of the fibers is accessible to and can be treated with the aerosol, which would otherwise not be possible if the bleached chemical pulp fiber was present as agglomerates of individual fibers. The individual bleached chemical pulp fibers may preferably have a moisture content of about 5 to 10 weight %, more preferably of about 7, 8 or 9 weight %, which is a moisture content that allows surface modifying compounds to more easily react with the constituent cellulose molecules of the individual bleached chemical pulp fibers.

Advantageously, the fiber length of the fibers of bleached chemical pulp fiber is controlled, such as for example by passing the milled pulp sheets through a mesh screen of 200 μm.

In a preferred embodiment, the bleached chemical pulp fiber may be made by chemically pulping and bleaching wood such as hardwood or softwood, or the bleached chemical pulp fiber may be made from plants such as hemp, rice straw, kenaf, jute, linen, coconut, banana, or sisal.

In a preferred embodiment of the process for producing surface modified bleached chemical pulp fiber according to the present invention, the aerosol comprises liquid particles of surface modifying composition, preferably having an average diameter of from 1 to 450 μm.

In a preferred embodiment of the process for producing surface modified bleached chemical pulp fiber according to the present invention, wherein the surface modifying composition comprises a dicarboxylic alkenoic anhydride grafted polyolefin as the surface modifying compound, such as maleic anhydride-grafted polypropylene (MAPP) or maleic anhydride-grafted polyethylene (MAPE).

In a preferred embodiment of the process for producing surface modified bleached chemical pulp fiber according to the present invention, the surface modifying composition is an aqueous, and preferably non-ionic, dispersion of the dicarboxylic alkenoic acid anhydride grafted polyolefin, preferably comprising of from 1 to 2 weight % of the dicarboxylic alkenoic acid anhydride grafted polyolefin.

In a preferred embodiment of the process for producing surface modified bleached chemical pulp fiber according to the present invention, the surface modifying composition comprises or consists of a silane (pure or in ethanol) according to formula I

(R₁)ₙSi(R₂)₄₋ₙ, (I)

as the surface modifying compound, where R₁ is a group capable of undergoing hydrolysis such as a C₁-C₁₀ alkoxy, —OH or a halogen, where n is a integer chosen from 1, 2 or 3, where R₂ can be independently a hydrogen, methyl, ethyl or a branched or linear alkyl or alkenyl chain having preferably 3 to 12 carbons and which may optionally be substituted; or a salt of a silane according to formula I, preferably a metal salt of a silane according to formula I. Exemplary branched or linear alkyl or alkenyl chain having preferably 3 to 12 carbons are methyl, ethyl, n- or iso-propyl, n-butyl or tert-butyl, pentyl, hexyl, heptyl, octyl, nonyl, decyl, undecyl, dodecyl, or vinyl, butenyl or propenyl and so on.

In a preferred embodiment of the process for producing surface modified bleached chemical pulp fiber according to the present invention, the surface modifying composition comprises or consists of a silane according to formula I as the surface modifying compound, where R₁ is C₁-C₁₀ alkoxy, where n is a integer chosen from 2 or 3, where R₂ can be independently a methyl, ethyl or a branched or linear alkyl chain having preferably 3 to 12 carbons. Exemplary C₁-C₁₀ alkoxy moieties which can be used are methoxy, ethoxy, n- or iso-propoxy and tert-butoxy and so on.

In a preferred embodiment of the process for producing surface modified bleached chemical pulp fiber according to the present invention, the surface modifying composition is a solution of one or more silanes according to formula I in an alcohol such as methanol or ethanol or an aqueous solution of a salt of one or more silane according to formula I, preferably an aqueous solution of a metal salt thereof and more preferably a alkali metal salt thereof. An exemplary salt are sodium or potassium methyl siloxane. Exemplary silanes according to formula I are aminopropylsilane, triethoxy octylsilane, propylsilane or isobutylsilane.

In a more preferred embodiment of the process for producing surface modified bleached chemical pulp fiber according to the present invention, the surface modifying composition comprises or consists of a silane (pure or in ethanol) according to formula I

(R₁)ₙSi(R₂)₄₋ₙ, (I)

as the surface modifying compound, where R₁ is —OH, where n is a integer chosen from 2 or 3, where R₂ is a branched or linear alkyl chain having preferably 3 to 4 carbons and which may optionally be substituted with an amino group such as for example when R₂ is propyl, isobutyl or aminopropyl.

In the case where the surface modifying composition is a solution of one or more silanes according to formula I in an alcohol, it is preferred to provide a certain water content in said solution. Advantageously, the solution of one or more silanes according to formula I in an alcohol has a water content of 5 weight %, or from 1 weight % to 9 weight %. In the case the surface modifying composition is a solution of one or more silanes according to formula I in an alcohol including water, the water is preferably adjusted to an acidic pH, preferably of from 4 to 5.

In a preferred embodiment of the process for producing surface modified bleached chemical pulp fiber according to the present invention where the surface modifying composition is a solution of one or more silanes according to formula I in an alcohol or an aqueous solution of a salt of one or more silanes according to formula I, the surface modifying composition may comprise of from 0.1 to 50 wt %, more preferably 10 to 40 wt % of the silane or salt thereof according to formula I.

In a preferred embodiment of the process for producing surface modified bleached chemical pulp fiber according to the present invention and in the case one or more silanes having according to formula I are used, and in particular in the case the surface modifying composition essentially consists of the surface modifying compound, the process may further include maintaining the water or moisture content of the bleached chemical pulp fiber within a range of about 5 to 10 weight %, more preferably of about 7, 8 or 9 weight %, while contacting the fluidized bleached chemical pulp fiber with an aerosol of a surface modifying composition comprising a surface modifying compound.

In a preferred embodiment of the process for producing surface modified bleached chemical pulp fiber according to the present invention and in the case one or more silanes having according to formula I are used, and the surface modifying composition is a solution of one or more silanes according to formula I in an alcohol, the alcohol may be dry alcohol or may more advantageously be an alcohol having a water content of 5 weight %, or from 1 weight % to 9 weight %.

In a preferred embodiment of the process for producing surface modified bleached chemical pulp fiber according to the present invention, the bleached chemical pulp fiber is modified with an amount of 0.1 to 10 wt % of surface modifying compound with respect to the weight of the bleached chemical pulp fiber. In particular, in the case the surface modifying compound comprises a silane, an amount of 1 to 5 wt % or 1 to 2 wt % of surface modifying compound with respect to the weight of the bleached chemical pulp fiber has been found to be advantageous, whereas in the case the surface modifying compound comprises a dicarboxylic alkenoic anhydride grafted polyolefin such as MAPP or MAPE, an amount of 2 to 10 wt % or about 4 to 5% of surface modifying compound with respect to the weight of the bleached chemical pulp fiber has been found to be advantageous.

In a preferred embodiment of the process for producing surface modified bleached chemical pulp fiber according to the present invention, the bleached chemical pulp fiber is fluidized in in a fluidized bed reactor.

In the case where the bleached chemical pulp fiber is fluidized in a fluidized bed, the fluidization may be achieved by passing the aerosol of surface modifying composition through the bleached chemical pulp fiber or may be achieved by passing a separate fluidization gas through the bleached chemical pulp fiber and spraying the aerosol of surface modifying composition onto the bleached chemical pulp fiber. In the latter case, the aerosol of surface modifying composition may be sprayed onto the bleached chemical pulp fiber either in essentially the same direction as the fluidization gas or in a different direction. In a preferred embodiment the aerosol of surface modifying composition may be sprayed onto the bleached chemical pulp fiber in essentially an opposite same direction as the fluidization gas, e.g. the aerosol of surface modifying composition is sprayed onto the bleached chemical pulp fiber in essentially a downward vertical direction whereas the fluidization gas is passed through the bleached chemical pulp fiber in essentially upward vertical direction.

In a preferred embodiment of the process for producing surface modified bleached chemical pulp fiber according to the present invention, the bleached chemical pulp fiber is fluidized in a mixing device, in particular by vibration or mechanical agitation of the bleached chemical pulp fiber. Exemplary mixing devices in which this fluidization can be achieved in a mixing device comprising at least a mixing cavity and a mixing means. The mixing means are capable of entraining the bleached chemical pulp fiber into a vortex or a device comprising at least a mixing cavity and a vibration means allowing for the formation of a vibratory fluidized bed. In both cases, the mixing cavity can be provided with an aerosol which may be generated in situ by for example an atomization nozzle or which may be fed into the mixing cavity from an aerosol source outside the mixing cavity.

Exemplary mixing means capable of entraining the bleached chemical pulp fiber into a vortex are stirrers, tumblers, paddles, impellers, blades, etc.

It is also an object of the present invention to provide a process for producing an agglomerate material comprising or essentially consisting of surface modified bleached chemical pulp fiber, comprising producing a surface modified bleached chemical pulp fiber according to any of the above, wetting the surface modified bleached chemical pulp fiber with a binder liquid, which may also be water, and agglomerating the wet surface modified bleached chemical pulp fiber into an agglomerate comprising or essentially consisting of surface modified bleached chemical pulp fiber, said agglomerates preferably having a bulk density of more than 50 g/dm³, or more than 80 g/dm³ or more than 190 g/dm³. The binder liquid may further comprise an aqueous solution of a binder polymer such as for example PVOH.

Agglomerating the wet surface modified bleached chemical pulp fiber may be achieved in a suitable agglomeration device, such as for example tumble dryers, paddle mixers, hot mixers, pin mixers, fluidized bed systems, high impact vertical mixers (e.g. Hosokawa flexomix), and is preferably carried out in a high impact vertical mixer.

In a preferred embodiment of the process for producing an agglomerate material comprising or essentially consisting of surface modified bleached chemical pulp fiber according to the present invention, the binder liquid is water and/or the agglomerate material comprising or essentially consisting of surface modified bleached chemical pulp fiber is preferably dried to a water content of no more than 5 wt %, no more than 2 wt %.

In a preferred embodiment of the process for producing an agglomerate material comprising or essentially consisting of surface modified bleached chemical pulp fiber according to the present invention, the agglomerate material comprising or essentially consisting of surface modified bleached chemical pulp fiber is essentially free of thermoplastic polymer other than the surface modifying compound such as MAPP or MAPE and/or a binder polymer, in particular is essentially free of a non-grafted thermoplastic polyolefin such as polypropylene or polyethylene.

It is also an object of the present invention to provide a process for producing a polymer composite material, comprising mixing a thermoplastic polymer in a melt with surface modified bleached chemical pulp fiber produced according above, where the surface modified bleached chemical pulp fiber is preferably in the form of agglomerate material comprising or essentially consisting of surface modified bleached chemical pulp fiber produced according above, wherein the thermoplastic polymer is preferably a thermoplastic polyolefin such as polypropylene or polyethylene.

In a preferred embodiment according to the process for producing a polymer composite material according to the present invention, mixing a thermoplastic polymer in a melt with surface modified bleached chemical pulp fiber is carried out in an extruder.

It is also an object of the present invention to provide surface modified bleached chemical pulp fiber, which when compared to the bleached chemical pulp fiber that has not been surface modified, requires at least 10%, at least 20%, at least 30%, at least 40%, at least 50% or at least 60% less energy to disperse in a thermoplastic polymer matrix, preferably via extrusion of the polymer matrix and the fiber, and optionally in the presence of an additional coupling agent. In particular, the surface modified bleached chemical pulp fiber is obtained according to the process for producing surface modified bleached chemical pulp fiber of the present invention.

It is also an object of the present invention to provide surface modified bleached chemical pulp fiber, requiring a specific energy of less than 0.2 kWh/kg, preferably less than 0.150 kWh/kg and more preferably less than 0.125 kWh/kg to disperse in a thermoplastic polymer matrix such as a polyolefin, preferably via extrusion of the polymer matrix and the fiber, and optionally in the presence of an additional coupling agent. In particular, the surface modified bleached chemical pulp fiber is obtained according to the process for producing surface modified bleached chemical pulp fiber of the present invention.

It is also an object of the present invention to provide an agglomerate material comprising or essentially consisting of comprising surface modified bleached chemical pulp fiber produced according to any of claims 1 to 10.

It is also an object of the present invention to provide process for producing a polymer composite material, comprising mixing a thermoplastic polymer in a melt with surface modified bleached chemical pulp fiber produced according to the present invention or agglomerate material produced according to the present invention, wherein the thermoplastic polymer is preferably a thermoplastic polyolefin such as polypropylene or polyethylene, and/or the amount of thermoplastic polymer comprised in the polymer composite material is of from 30 to 99 weight percent and/or the amount of surface modified bleached chemical pulp fiber comprised in the polymer composite material is of from 1 to 70 weight percent, based on the total weight of the polymer composite material.

In a preferred embodiment of the process for producing a polymer composite material, the amount of thermoplastic polymer is of from 60 to 90 weight percent and/or the amount of surface modified bleached chemical pulp fiber comprised in the polymer composite material is of from 10 to 40 weight percent, based on the total weight of the polymer composite material.

It is also an object of the present invention to provide a polymer composite material, preferably in pellet form, obtained by mixing a thermoplastic polymer in a melt with surface modified bleached chemical pulp fiber or agglomerate material according to the present invention, where the surface modified bleached chemical pulp fiber is preferably in the form of agglomerate material comprising or essentially consisting of surface modified bleached chemical pulp fiber produced according to the present invention.

In a preferred embodiment of the polymer composite material according to the present invention, the modified bleached chemical pulp fiber requires a specific energy of less than 0.2 kWh/kg, preferably less than 0.150 kWh/kg and more preferably less than 0.125 kWh/kg to disperse in the thermoplastic polymer matrix such as a polyolefin, preferably via extrusion of the polymer matrix and the fiber, and optionally in the presence of an additional coupling agent such as a dicarboxylic alkenoic anhydride grafted polyolefin. In particular, the surface modified bleached chemical pulp fiber is obtained according to the process for producing surface modified bleached chemical pulp fiber of the present invention.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows agglomerate material essentially consisting of surface modified bleached chemical pulp fibre.

### DESCRIPTION OF PREFERRED EMBODIMENTS

### Surface Modification of Bleached Chemical Pulp Fiber

Surface modified bleached chemical pulp fiber was produced by fluidizing bleached chemical pulp fiber in a heated laboratory stirrer device equipped with a double stirrer blade equipped with side tip scrapers. The top lid was provided with a hole from where the aerosol of triethoxy(octyl)silane could be applied onto the fluidized bleached chemical pulp fiber. The aerosol of surface modifying composition of triethoxyoctylsilane was delivered while the stirrer device was operated at 100 rpm until an amount corresponding to approx. 2 wt %, with respect to the bleached chemical pulp fiber weight was applied. After the surface modifying composition of triethoxyoctylsilane has been delivered, the stirrer device was operated further at 200 rpm to homogenize for 15 minutes at room temperature and then reduced to 100 rpm and the temperature is increased to a temperature of approximately 95° C. The speed and temperature were maintained for another 20 minutes to cure the triethoxyoctylsilane to the fibres. After cooling back to room temperature, the surface modified bleached chemical pulp fiber was recuperated.

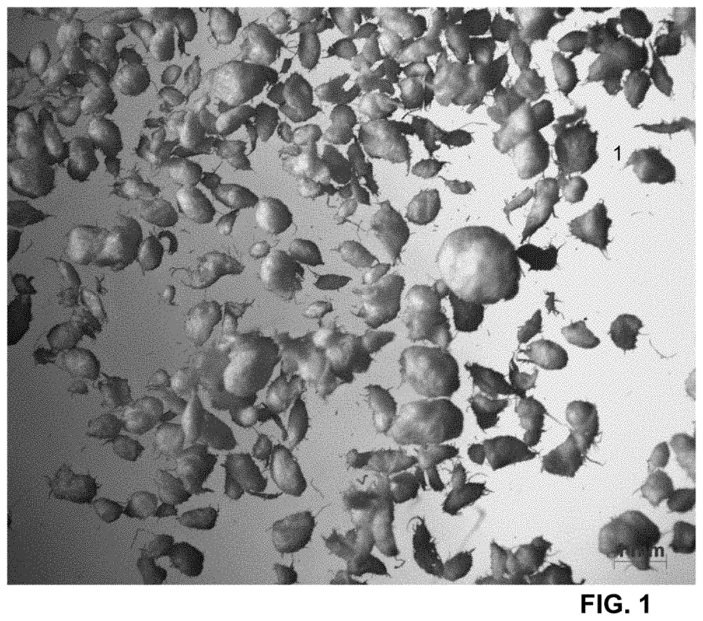

The surface modified bleached chemical pulp fiber were then agglomerated in a household blender. The fibres were wetted with approximately 150 parts per hundred fiber (phf) of water while operating the blender until they started to agglomerate. The agglomerate material was then collected and dried in an oven at 80° C. for several hours until dry. The agglomerate material is shown in FIG. 1.

The aggregate material of surface modified bleached chemical pulp fiber was the used in extrusion trials aimed at determining the specific energy needed to disperse the surface modified bleached chemical pulp fibers in a polyolefin matrix.

In the case of bleached chemical pulp fiber that were not surface modified and used as comparative, the agglomerate material was obtained according to the same procedure described above with the exception that the formation of agglomerates needed more water, i.e. approximately 200 parts per hundred fiber (phf) of water.

### Comparative

40 parts of bleached chemical wood pulp fiber obtained by grinding corresponding pulp sheets in a knife mill and screened over 200 μm mesh in the form of agglomerated material, 57 parts of homopolymer PP having a MFI of 47 when measured at 230° C. using a 2.16 kg load, and 3 parts MAPP coupling agent were combined into a polymer composite on a Coperion ZSK26 Mc18 co-rotating twin screw extruder equipped with screws of 25 mm in diameter and having a L/D ratio of 44.

The extruder contained 11 barrel unit sections on which the main hopper was located on section 1, a first side-feeding unit was provided at section 4, a second side-feeding unit was provided at section 7. The screws comprised several kneading sections: 3 kneading zones between section 4 and 7 and 4 kneading zones between section 7 and 11.

The minimal specific energy needed to obtain a polymer composite in which no flock could be identified via visual inspection was determined as being 0,240 kWh/kg when the bleached chemical wood pulp fiber was dosed via the first side-feeding unit at section 4 with at a screw rotation speed of 400 rpm at a total throughput was 15 kg/h. When lesser specific energy was used, by for example reducing the screw speed or feeding the fiber more downstream a suboptimal dispersion of the fibers and visible flocks within the polymer composite was observed.

### Inventive

A polymer composite was obtained according to the same protocol as above, with the exception that the fiber was surface modified bleached chemical wood pulp fiber obtained according to the above described embodiment of the present invention.

The minimal specific energy needed to obtain a polymer composite in which no flock could be identified via visual inspection was determined as being 0,115 kWh/kg when the bleached chemical wood pulp fiber was dosed via the second side-feeding unit at section 7 (i.e. bypassing kneading zones between section 4 and 7) with at a screw rotation speed of 120 rpm at a total throughput was 15 kg/h.

Thus, the surface modified bleached chemical pulp fiber allows to incorporate bleached chemical pulp fiber into a polymer matrix at the same dispersion level but using about 50% less energy when compared to the bleached chemical pulp fiber that has not been surface treated.

### LIST OF REFERENCE SIGNS

none

1. A process for producing surface modified bleached chemical pulp fiber comprising fluidizing a bleached chemical pulp fiber and contacting the fluidized bleached chemical pulp fiber with an aerosol of a surface modifying composition comprising a surface modifying compound.

2. The process for producing surface modified bleached chemical pulp fiber according to claim 1, wherein the aerosol comprises liquid particles of surface modifying composition.

3. The process for producing surface modified bleached chemical pulp fiber according to claim 1, wherein the bleached chemical pulp fiber is modified with an amount of 0.1-10 wt % of surface modifying compound with respect to the weight of the bleached chemical pulp fiber.

4. The process for producing surface modified bleached chemical pulp fiber according to claim 1, wherein the surface modifying composition comprises a dicarboxylic alkenoic anhydride grafted polyolefin as the surface modifying compound.

5. The process for producing surface modified bleached chemical pulp fiber according to claim 1, wherein the surface modifying composition is an aqueous dispersion of the dicarboxylic alkenoic acid anhydride grafted polyolefin.

6. The process for producing surface modified bleached chemical pulp fiber according to claim 1, wherein the surface modifying composition comprises, or consists of, a silane or a salt of said silane, according to formula I
(R₁)ₙSi(R₂)₄₋ₙ, (I)
as the surface modifying compound, where R₁ is a group capable of undergoing hydrolysis, where n is a integer chosen from 1, 2 or 3, where R₂ is independently a hydrogen, methyl, ethyl or a alkyl chain having 3 to 10 carbons.

7. The process for producing surface modified bleached chemical pulp fiber according to claim 6, wherein the surface modifying composition is a solution of a silane according to formula I in an alcohol; or an aqueous solution of a salt of said silane.

8. The process for producing surface modified bleached chemical pulp fiber according to claim 6, wherein the surface modifying composition comprises of from 2 to 50 wt of the silane according to formula I.

9. The process for producing surface modified bleached chemical pulp fiber according to claim 1, wherein the bleached chemical pulp fiber is fluidized in a fluidized bed reactor.

10. The process for producing surface modified bleached chemical pulp fiber according to claim 1, wherein the bleached chemical pulp fiber is fluidized in a mixing device.

11. The process for producing surface modified bleached chemical pulp fiber according to claim 1, wherein the surface modified bleached chemical pulp fiber is dried to a water content of no more than of about 5 wt %.

12. A process for producing an agglomerate material comprising or essentially consisting of surface modified bleached chemical pulp fiber, where the surface modified bleached chemical pulp fiber is produced by fluidizing a bleached chemical pulp fiber and contacting the fluidized bleached chemical pulp fiber with an aerosol of a surface modifying composition comprising a surface modifying compound; and comprising the steps of wetting said surface modified bleached chemical pulp fiber with a binder liquid, and agglomerating the wet surface modified bleached chemical pulp fiber into an agglomerate material comprising or essentially consisting of said surface modified bleached chemical pulp fiber, where said agglomerate material has a bulk density of more than 80 g/dm³.

13. The process for producing an agglomerate material according to claim 12, where the binder liquid is water and wherein the agglomerate material comprising or essentially consisting of surface modified bleached chemical pulp fiber is dried to a water content of no more than 5 wt %.

14. The process for producing an agglomerate material according to claim 12, where the agglomerate material comprising or essentially consisting of surface modified bleached chemical pulp fiber is essentially free of non-grafted thermoplastic polyolefin.

15. An agglomerate material comprising or essentially consisting of comprising surface modified bleached chemical pulp fiber, where the surface modified bleached chemical pulp fiber is produced by fluidizing a bleached chemical pulp fiber and contacting the fluidized bleached chemical pulp fiber with an aerosol of a surface modifying composition comprising a surface modifying compound; which agglomerate material is obtained by wetting the surface modified bleached chemical pulp fiber with a binder liquid, and agglomerating the wet surface modified bleached chemical pulp fiber into an agglomerate material comprising or essentially consisting of surface modified bleached chemical pulp fiber, where said agglomerate material has has a bulk density of more than 80 g/dm³.

16. A process for producing a polymer composite material, comprising mixing a thermoplastic polymer in a melt with a surface modified bleached chemical pulp fiber, where the surface modified bleached chemical pulp fiber is produced by fluidizing a bleached chemical pulp fiber and contacting the fluidized bleached chemical pulp fiber with an aerosol of a surface modifying composition comprising a surface modifying compound; or with an agglomerate material produced by wetting the surface modified bleached chemical pulp fiber with a binder liquid, and agglomerating the wet surface modified bleached chemical pulp fiber into an agglomerate material comprising or essentially consisting of surface modified bleached chemical pulp fiber, where said agglomerate material has a bulk density of more than 80 g/dm³, wherein the thermoplastic polymer is a thermoplastic polyolefin, and the amount of thermoplastic polymer comprised in the polymer composite material is of from 30 to 99 weight percent and the amount of surface modified bleached chemical pulp fiber comprised in the polymer composite material is of from 1 to 70-weight percent, based on the total weight of the polymer composite material.

17. The process for producing surface modified bleached chemical pulp fiber according to claim 1, wherein to aerosol comprises liquid particles of surface modifying composition having an average diameter of from 1 to 450 μm.

18. The process for producing surface modified bleached chemical pulp fiber according to claim 1, wherein the surface modifying composition comprises a maleic anhydride-grafted polypropylene (MAPP) or a maleic anhydride-grafted polyethylene (MAPE) as the surface modifying compound.

19. The process for producing surface modified bleached chemical pulp fiber according to claim 1, wherein the surface modifying composition is an aqueous dispersion of a dicarboxylic alkenoic acid anhydride grafted polyolefin comprising of from 5 to 10 wt % of the dicarboxylic alkenoic acid anhydride grafted polyolefin.

20. The process for producing surface modified bleached chemical pulp fiber according to claim 1, wherein the surface modifying composition comprises, or consists of, a silane or a salt of said silane, according to formula I
(R₁)ₙSi(R₂)₄₋ₙ, (I)
as the surface modifying compound, where R₁ is C₁-C₁₀ alkoxy, —OH or a halogen, where n is a integer chosen from 1, 2 or 3, where R₂ is independently a hydrogen, methyl, ethyl, or a branched alkyl or alkenyl chain having 3 to 10 carbons, or a linear alkyl or alkenyl chain having 3 to 10 carbons.
